(19) United States
(12) Patent Application Publication
(10) Pub. No.: US 2011/0247953 A1
(43) Pub. Date: Oct. 13, 2011

(54) EMERGENCY GAS AND WATER SHUTOFF TOOL

(76) Inventor: Richard Edwards, Westminster, CA (US)

(21) Appl. No.: 12/755,535

(22) Filed: Apr. 7, 2010

(51) Int. Cl. B25F 1/00; B25B 13/06; B65D 85/00

(52) U.S. Cl. 206/373; 206/378; 7/168; 81/124.7

(57) ABSTRACT

Provided is an emergency gas shutoff key and a water shutoff assembly for closing a gas valve and water valve, respectively. The gas shutoff key and water shutoff assembly are sized and configured for storage near the gas valve and water valve. In particular, the gas shutoff key includes a key body having a pair of keyholes formed therein. Each keyhole is configured to receive the gas valve stem for controlling the gas valve. The gas key further includes a hook for hanging on a gas pipe, and a stem for opening the water vault. The water shutoff assembly includes a water control axle and a lever arm sized to be insertable through a bore formed within the water control axle. The water control axle includes a water keyhole sized to receive the water valve stem for controlling the water valve.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to shutoff tools for utility valves, and more specifically, to a gas shutoff tool and a water shutoff tool which may be stored near the gas valve and water valve, respectively.

Many of today's appliances utilize natural gas or water during normal usage of the appliances. Exemplary appliances include stoves, ovens, hot water heaters, central heaters, washers, dryers, boilers and furnaces. Accordingly, residential communities typically include an infrastructure for supplying and delivering the gas and water to each residence. Along these lines, each residence typically includes a gas valve and a water valve for controlling the flow of gas and water from the infrastructure to the respective home. The gas valve is typically located near the gas meter, while the water valve is typically located in a concrete vault partially submerged in the ground. Each gas valve and water valve generally includes a valve stem which is rotatable to control fluid flow through the valve.

In certain situations, it may be desirable to close the valves to stop the flow of gas or water to the home. For instance, during construction or remodeling of the home, the gas and water valves may be closed to mitigate damage caused by an accidental rupture of one of the gas or water lines, or to enable replacement or maintenance of one of the gas or water lines. Furthermore, in the event of an emergency, such as a flood, landslide, tornado, hurricane, or earthquake, it may be advantageous to close the gas valve and water valve. If the gas or water lines were to rupture during such a catastrophes event, it could trigger a fire, or cause flood damage.

Closing the gas valve and the water valve generally requires a ¼ turn (ninety degrees) of the respective valve stem, which may be very difficult because after years of non-use, the valves tend to stick. In some cases, the valve stems may start to corrode. Therefore, tools are typically required to turn the valve stems.

The tools tend to be relatively large so as to generate enough torque to turn the valves stems. The tools are generally not stored at the site of the gas valve or the water valve because of their large size. Particularly with regard to the water valve, the water shutoff tool is typically too large to fit within the concrete water vault. Furthermore, since the tools are used infrequently, the tools are typically stored in remote locations (i.e., a storage shed, a garage attic, etc.) to keep them out of the way of more routine activities. As a result, many tools are misplaced, or their storage location is forgotten. During an emergency, or immediately before an impending emergency, it is undesirable to have to search for the gas and water shutoff tools.

In addition to the foregoing, an additional tool may be required to open the concrete water vault to access the water valve. More specifically, the concrete water vault typically includes a concrete cover which must be removed before access to the water valve stem can be attained. Most covers include a slot configured to receive a tool for engaging the cover to enable a user to lift the cover off of the water vault. A separate vault opening tool is another tool for the user to store and subsequently locate when the water and gas valves need to be closed, which may add to the user's stress and frustration.

As is apparent from the foregoing, there exists a need in the art for a gas shutoff tool and a water shutoff tool which are sized and configured for storage at the site of the gas shutoff valve and the water shutoff valve, respectively, and which can also be used to lift the water vault cover off the water vault. The present invention addresses these particular needs, as will be discussed in more detail below.

### BRIEF SUMMARY

Provided is an emergency gas shutoff key and a water shutoff assembly for closing a gas valve and water valve, respectively. The gas shutoff key and water shutoff assembly are sized and configured for storage near the gas valve and water valve. Along these lines, it is understood that most residential water valves are located in a submerged concrete vault. Therefore, the water shutoff assembly is designed for storage within the concrete vault. Furthermore, the gas shutoff key may stored near the gas valve and may be configured for use in removing the vault lid to access the water valve and the water shutoff assembly. The storage of the gas shutoff key and water shutoff assembly allows a user to quickly and easily close the gas valve and water valve without having to search for remotely stored shutoff tools.

According to one embodiment, the gas key and water shutoff assembly are included in a gas and water shutoff kit. The gas key includes a key body having a first keyhole and a second keyhole formed within the key body. The first gas keyhole extends along a first longitudinal axis and the second gas keyhole extends along a second longitudinal axis angularly offset from the first longitudinal axis. The first gas keyhole and the second gas keyhole are configured to be engageable with a gas valve stem to control the gas valve. The gas key further includes a hook connected to the key body for hanging the gas key on a gas pipe near the gas valve. The gas key additionally includes a stem connected to the key body. The stem is configured for insertion into a cover opening formed on the water vault cover for removing the vault cover to access the water valve. The water shutoff assembly includes a water control axle having a first end portion and a second end portion, with a water keyhole being formed adjacent the first end portion and a lever bore being formed adjacent the second end portion. The water keyhole is configured to receive the water valve stem for moving the water valve stem to control the water valve. The water shutoff assembly additionally includes a lever arm sized to be insertable through the lever bore to engage with the water control axle to effectuate movement of the water control axle for controlling the water valve.

The water shutoff assembly may assume a storage configuration for storage within the water vault during non-use when the lever arm is removed from the lever bore. The water shutoff assembly may assume an assembly configuration when the lever arm is inserted through the lever bore.

The gas key and water shutoff assembly are best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an upper perspective view of a utility kit including a gas shutoff key being used to open a concrete water vault having a water shutoff assembly stored therein;

FIG. 2 is an upper perspective view of the water shutoff assembly in an assembled configuration for closing a water valve;

FIG. 3 is a top view of the gas shutoff key and the water shutoff assembly, wherein the water shutoff assembly includes a water control axle and a lever arm;

FIG. 4 is an end view of the water control axle;

FIG. 5 is an upper perspective view of the gas shutoff key hanging on a gas pipe adjacent a gas valve; and

FIG. 6 is an upper perspective view of the gas shutoff key being aligned with a gas valve stem to close the gas valve.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

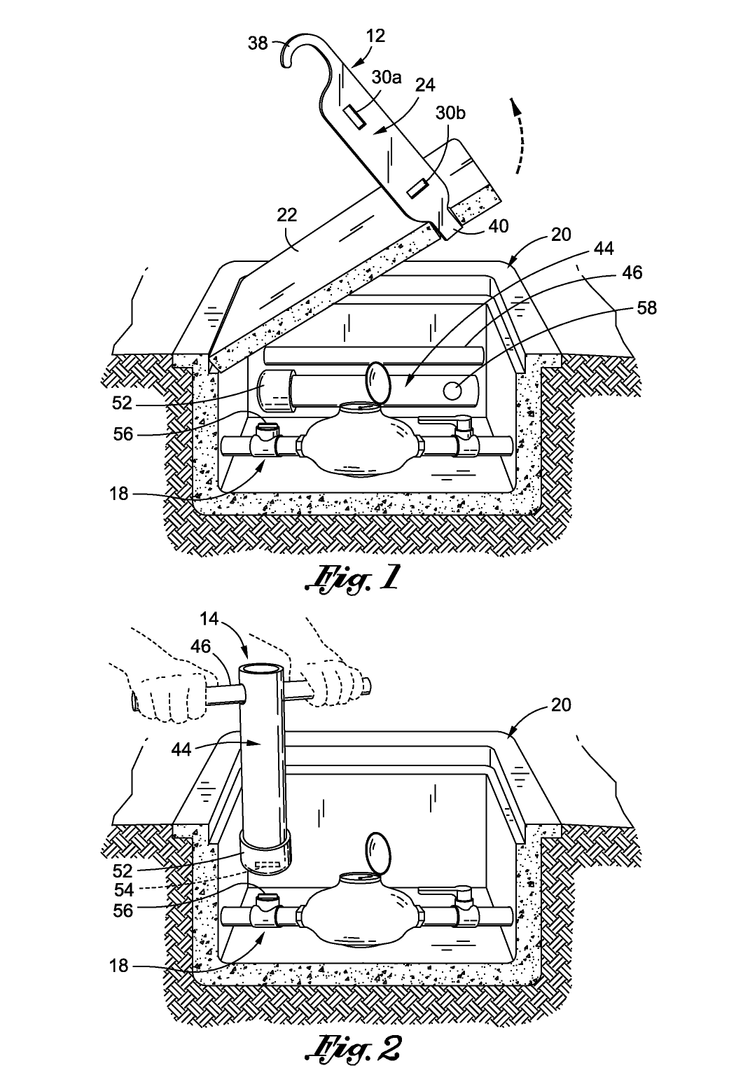

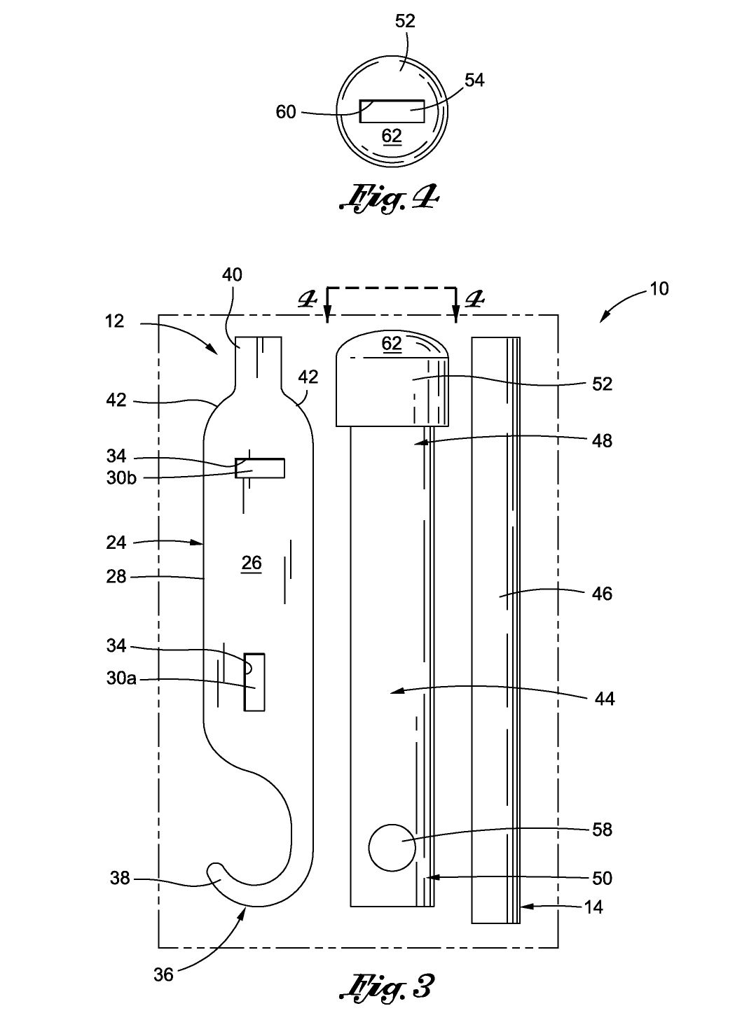

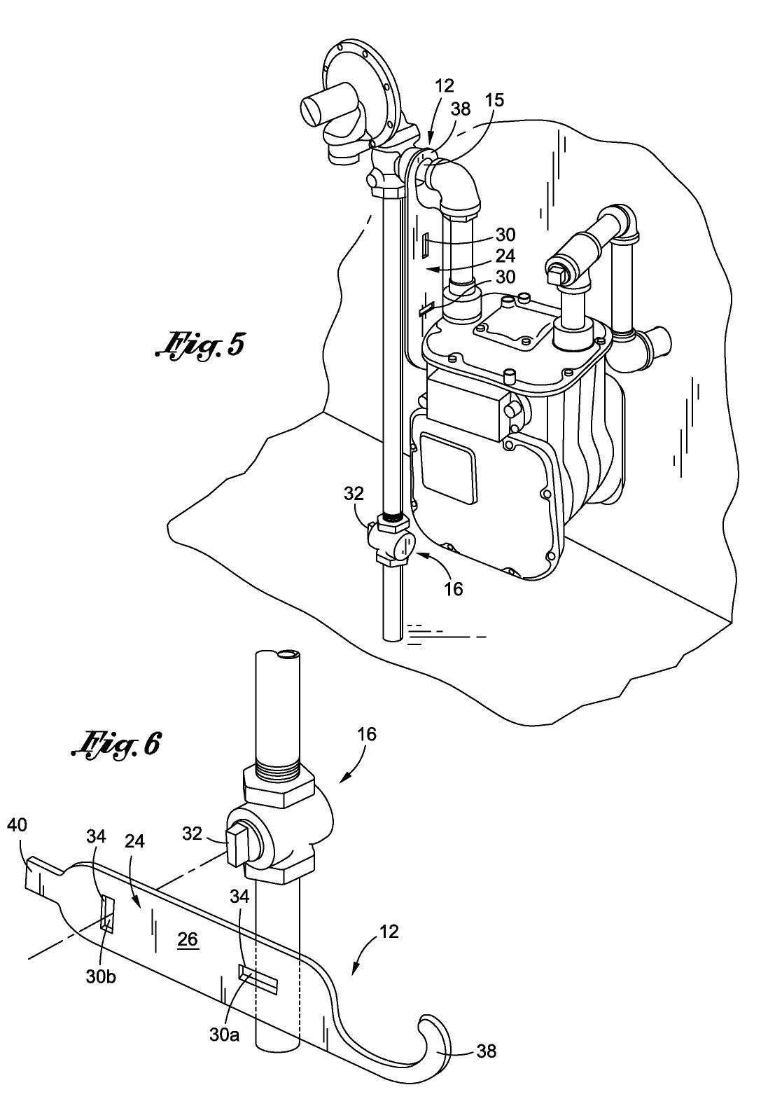

Referring now to the drawings, there is depicted a utility shutoff kit 10 (see FIG. 3) including a gas shutoff key 12 (see FIG. 3) and a water shutoff assembly 14 (see FIG. 3) for closing a gas valve 16 (see FIG. 6) and a water valve 18 (see FIG. 2), respectively. The gas shutoff key 12 and water shutoff assembly 14 are advantageously sized and configured for storage near the respective valves 16, 18. In particular, the gas shutoff key 12 is configured to hang on a gas pipe 15 (see FIG. 5) near the gas valve 16, while the water shutoff assembly 14 is configured for storage within a concrete water vault 20 (see FIGS. 1 and 2) housing the water valve 18. Therefore, the user does not need to search for the gas and water shutoff tools 12, 14 during a time of crisis. Instead, the user can go right to the valves 16, 18 and know that the shutoff tools 12, 14 will be there. The gas shutoff key 12 may also be configured to facilitate removal of the water vault cover 22 (see FIG. 1) from the water vault 20 to mitigate the need for a separate tool for removing the vault cover 22.

When the time comes to shutoff the utilities to a home, a user may simply shutoff the gas using the gas shutoff key 12 hanging near the gas valve 16. The user may then remove the vault cover 22 with the gas shutoff key 12 to access the water shutoff assembly 14 to close the water valve 18. It is envisioned that the gas shutoff key 12 and the water shutoff assembly 14 may be either sold as a kit 10, or as separate units.

The gas shutoff key 12 includes a key body 24 (see FIGS. 1 and 3) having a pair of generally planar, opposing body surfaces 26 (see FIG. 3), and a peripheral wall 28 (see FIG. 3) extending between the opposing body surfaces 26 to define a generally uniform thickness. The gas shutoff key 12 additionally includes a pair of gas keyholes 30a, 30b (see FIGS. 1, 3, and 6) formed within the gas key body 24. The pair of keyholes 30a, 30b depicted in the figures are disposed in space relation to each other, and are arranged orthogonally relative to each other. In particular, the first keyhole 30a extends longitudinally along a first longitudinal axis, while the second keyhole 30b extends longitudinally along a second longitudinal axis orthogonal to the first longitudinal axis. However, it is contemplated that the keyholes 30a, 30b may define other angular orientations without departing from the spirit and scope of the present invention. It is also contemplated that other implementations of the gas shutoff key 12 may include only one keyhole or more than two keyholes.

The keyholes 30a, 30b are sized to receive a valve stem 32 (see FIG. 6) extending from the gas valve 16. In this manner, each keyhole 30a, 30b is defined by a key wall 34 (see FIG. 6) which is complimentary to the shape of the valve stem 32. The exemplary keyholes 30a, 30b depicted in the figures are rectangular in shape, but can define other shapes such as triangles, ovals, or other polygons. The key wall 34 may extend through the entire thickness of the gas key body 24 (i.e., from one body surface 26 to the other body surface 26) or only partially through the thickness of the gas key body 24 (i.e., from one body surface 26 toward the other body surface 26).

The user places the gas shutoff key 12 over the valve stem 32 with the stem 32 being advanced into the keyhole 30. The key wall 34 circumnavigates the valve stem 32 when the valve stem 32 is advanced into the keyhole 30a, 30b. The key wall 34 is sized to allow the valve stem 32 to be easily advanced into the keyhole 30a, 30b, while at the same time providing a snug fit between the key wall 34 and the valve stem 32, so that when the gas shutoff key 12 is rotated a certain amount, the valve stem 32 also rotates substantially the same amount.

In deciding which keyhole 30a, 30b to use, the user may utilize the keyhole 30a, 30b which provides the greatest mechanical advantage to the user. In other words, when the gas shutoff key 12 is placed on the valve stem 32, one keyhole 30a, 30b may dispose the gas shutoff key 12 in a more desirable angular orientation for purposes of rotating the gas shutoff key 12 than the other keyhole 30b. In addition, it is understood that the gas valve 16 may be located adjacent a wall, fence, or other structure which may complicate rotation of the gas key 12. Therefore, the user may utilize the keyhole 30a, 30b which places the gas shutoff key 12 in a favorable position relative to any adjacent structure.

The gas shutoff key 12 is sized and configured to be grippable by a user to rotate the gas shutoff key 12 when disposed on a valve stem 32. The user typically grips the gas shutoff key 12 adjacent an end portion of the gas shutoff key 12 opposite the keyhole 30a, 30b being used. The key body 24 may be fabricated from a material strong enough to withstand the torque required to rotate the valve stem 32. The material should also be capable of withstanding long periods of exposure to the outside environment, as the gas shutoff key 12 may be stored outside, as discussed below. An exemplary material includes, but is not limited to, plastic materials.

The gas shutoff key 12 further includes an attachment element 36 (see FIG. 3) for storing the gas shutoff key 12 near the gas valve 16. In the exemplary embodiment, the attachment element 36 includes a hook 38 (see FIG. 3) integrally connected to the key body 24. The hook 38 is sized and configured to hang from a gas pipe 15 adjacent the gas valve 16 (see FIG. 5). Therefore, the user may not be required to look for the gas shutoff key 12 when the time comes to close the gas valve 16, because the gas shutoff key 12 should be hanging by the gas valve 16.

Other embodiments of the attachment element 36 may include a moveable portion capable of moving between an open position to allow the gas shutoff key 12 to be placed on the gas pipe 15, and a closed position to secure the gas shutoff key 12 to the pipe 15. Such a device may include a spring loaded clip, or other similar devices known in the art. A spring loaded clip may completely enclose the pipe by the gas shutoff key 12 to mitigate accidental falling off of the pipe by the gas shutoff key 12.

Referring now to FIG. 1, the gas shutoff key 12 additionally includes a stem 40 for use in removing the water vault cover 22 from the water vault 20. In the exemplary embodiment, the stem 40 is located opposite the attachment element 36 and is sized and configured to fit into a slot formed on the vault cover 22 (see FIG. 1). According to one implementation, the stem 40 extends from the key body 24 along a stem longitudinal axis, and is insertable within the cover slot when the stem longitudinal axis is substantially perpendicular to the plane defined by the vault cover 22. The stem 40 assumes an insertion orientation when the stem longitudinal axis is substantially perpendicular to the plane defined the vault cover 22. The stem 40 is additionally configured to engage with the vault cover 22 when the stem 40 is inserted into the slot formed within the vault cover 22 and is pivoted from the insertion orientation to wedge the stem 40 in the cover slot. The user may then lift the cover 22 to access the water vault 20. The gas shutoff key 12 may include rounded edges 42 (see FIG. 3) adjacent the stem 40 to accommodate the pivoting movement described above.

Once the vault cover 22 is removed, the user can access the water valve 18 and the water shutoff assembly 14 stored within the vault 20. The water shutoff assembly 14 is configured to assume a storage configuration (see FIG. 1) for convenient storage within the vault 20, allowing the user to rest assured that the water shutoff assembly 14 may be easily located in times of crisis. The water shutoff assembly 14 may be easily deployed from the storage configuration to an assembled configuration (see FIG. 2) to turn off the water valve 18.

The water shutoff assembly 14 includes a water control axle 44 (see FIGS. 1-3) and a lever arm 46 (see FIGS. 1-3). The exemplary embodiment includes a cylindrical water control axle 44 and lever arm 46, with the water control axle 44 defining an outer diameter larger than the lever arm 46. The water control axle 44 includes a first end portion 48 (see FIG. 3) and an opposing second end portion 50 (see FIG. 3). The water control axle 44 may include an end cap 52 (see FIGS. 3 and 4) disposed over the first end portion 48, with the end cap 52 having a water keyhole 54 (see FIGS. 2 and 4) formed therein. The water keyhole 54 is configured to receive a water valve stem 56 (see FIG. 1) for controlling the water valve 18. The end cap 52 may be detachable from the axle 44 and may be coupled to the axle by complimentary threads and grooves, by an adhesive, by press-fit engagement, or by other mechanical attachment means known in the art. In another implementation, the end cap 52 is integrally formed with the axle 44.

The water keyhole 54 is defined by a water key wall 60 extending inwardly from an outer surface 62 (see FIGS. 3 and 4) of the water control axle 44. The water keyhole 54 is complimentary in shape to the water valve stem 56 to provide a tight snug fit over the water valve stem 56. Therefore, when the water control axle 44 rotates a certain amount, the water valve stem 56 also rotates substantially the same amount.

A lever bore 58 (see FIG. 3) is formed within the water control axle 44 adjacent the second end portion 50 thereof. The lever arm 46 is sized to be insertable through the lever bore 58 to engage with the water control axle 44 and assume the assembled configuration. When assembled, the water shutoff assembly 14 may be used to effectuate movement (i.e., rotation) of the water stem 56 to control the water valve 18.

When the user opens the water vault 20, the water shutoff assembly 14 will likely be in the storage configuration (see FIG. 1). The user then disposes the water shutoff assembly 14 in the assembled configuration by inserting the lever arm 46 through the lever bore 58 formed within the water control axle 44 (see FIG. 2). Then the user then disposes the water control axle 44 over the water valve stem 56 to advance the water valve stem 56 into the water keyhole 54. The user then rotates the water control axle 44 to close the water valve 18. The lever arm 46 provides the user with an ergonomic gripping surface, as well as a mechanical advantage for rotating the water valve stem 56.

The water shutoff assembly 14 may be manufactured from a strong durable material capable of withstanding long periods of storage within the submerged concrete vault 20. An exemplary material includes a plastic material, or other similar materials known by those skilled in the art.

It is envisioned that the gas shutoff key 12 and water shutoff assembly 14 may be packaged together and sold as a utility shutoff kit 10. Alternatively, it is additionally contemplated that the gas shutoff key 12 and water shutoff assembly 14 may be sold as separate units.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A gas and water shutoff kit for use with a gas system and a water system, the gas system including a gas pipe and a gas valve actuated by a gas valve stem, the water system having a water valve actuated by a water valve stem, the water valve being disposed within a water vault including a vault cover having a cover opening formed therein, the gas and water shutoff kit comprising:
a gas key including:
a key body having a first keyhole and a second keyhole formed therein, the first gas keyhole extending along a first longitudinal axis and the second gas keyhole extending along a second longitudinal axis angularly offset from the first longitudinal axis, the first and second gas keyholes being configured to receive the gas valve stem for moving the gas valve stem to control the gas valve;
a hook connected to the key body and configured to be disposable on the gas pipe to hang therefrom; and
a stem connected to the key body, the stem being sized and configured to be insertable within the cover opening; and
a water shutoff assembly including:
a water control axle having a first end portion and a second end portion, the water control axle including a water keyhole formed adjacent the first end portion and a lever bore formed adjacent the second end portion, the water keyhole being configured to receive the water valve stem for moving the water valve stem to control the water valve; and
a lever arm sized to be insertable through the lever bore to engage with the water control axle to effectuate movement of the water control axle for controlling the water valve.

2. The kit recited in claim 1, wherein the water control axle and lever arm are sized and configured to be disposable within the water vault for storage during non-use.

3. The kit recited in claim 2, wherein the water shutoff assembly assumes a storage configuration when the lever arm is removed from the lever bore, and the lever arm and water control axle assume an assembled configuration when the lever arm is inserted through the lever bore.

4. The kit recited in claim 1, wherein the water control axle and lever arm are fabricated from a plastic material.

5. The kit recited in claim 1, wherein the water control axle defines an outer surface and a water key wall extending from the outer surface to define the water keyhole, the water key wall being configured to circumnavigate and engage the water valve stem when the water valve stem is received within the water keyhole.

6. The kit recited in claim 1, wherein the second longitudinal axis extends generally orthogonally relative to the first longitudinal axis.

7. The kit recited in claim 1, wherein the stem of the gas key is configured to be engageable with the cover and to support the weight of the cover as it is lifted off the water vault.

8. The kit recited in claim 1, wherein the gas key includes a pair of opposed external surfaces defining a thickness therebetween, the gas key further including a gas key wall extending from one of the external surface into the gas key to define the gas keyhole, the gas key wall being configured to circumnavigate and engage the gas valve stem when the gas valve stem is received within the gas keyhole.

9. The kit recited in claim 1, wherein the stem extends from the key body along a stem longitudinal axis, the stem being insertable within the cover opening when the stem longitudinal axis is substantially perpendicular to the plane defined by the vault cover.

10. The kit recited in claim 9, wherein the stem assumes an insertion orientation when the stem longitudinal axis is substantially perpendicular to the plane defined by the vault cover, the stem being configured to engage with the vault cover when the stem is inserted in the cover opening and pivoted from the insertion orientation.

11. The kit recited in claim 1, wherein the gas key is fabricated out of a plastic material.

12. A gas key for use with a gas system and a water system, the gas system including a gas pipe and a gas valve actuated by a gas valve stem, the water system having a water valve disposed within a water vault including a vault cover having a cover opening formed therein, the gas key comprising:
a key body having a first keyhole and a second keyhole formed therein, the first gas keyhole extending along a first longitudinal axis and the second gas keyhole extending along a second longitudinal axis angularly offset from the first longitudinal axis, the first and second gas keyholes being configured to receive the gas valve stem for moving the gas valve stem to control the gas valve;
a hook connected to the key body and configured to be disposable on the gas pipe to hang therefrom; and
a stem connected to the key body, the stem being sized and configured to be insertable within the cover opening.

13. The gas key recited in claim 12, wherein the second longitudinal axis extends generally orthogonally relative to the first longitudinal axis.

14. The gas key recited in claim 12, wherein the stem of the gas key is configured to be engageable with the cover and to support the weight of the cover as it is lifted off the water vault.

15. The gas key in claim 12, wherein the gas key includes a pair of opposed external surfaces defining a thickness therebetween, the gas key further including a gas key wall extending from one of the external surface into the gas key to define the gas keyhole, the gas key wall being configured to circumnavigate and engage the gas valve stem when the gas valve stem is received within the gas keyhole.

16. The kit recited in claim 12, wherein the stem extends from the key body along a stem longitudinal axis, the stem being insertable within the cover opening when the stem longitudinal axis is substantially perpendicular to the plane defined by the vault cover.

17. The kit recited in claim 16, wherein the stem assumes an insertion orientation when the stem longitudinal axis is substantially perpendicular to the plane defined by the vault lie, the stem being configured to engage with the vault cover when the stem is inserted in the cover opening and pivoted from the insertion orientation.

18. A water shutoff assembly for use with a water system having a water valve actuated by a water valve stem, the water valve being disposed within a water vault, the water shutoff assembly comprising:
a water control axle having a first end portion and a second end portion, the water control axle including a water keyhole formed adjacent the first end portion and a lever bore formed adjacent the second end portion, the water keyhole being configured to receive the water valve stem for moving the water valve stem to control the water valve; and
a lever arm sized to be insertable through the lever bore to engage with the water control axle to effectuate movement of the water control axle for controlling the water valve.

19. The water shutoff assembly recited in claim 18, wherein the water shutoff assembly assumes a storage configuration when the lever arm is removed from the lever bore, and the lever arm and water control axle assume an assembled configuration when the lever arm is inserted through the lever bore, the lever arm and water control axle being sized and configured to fit in the water vault in the storage configuration.

20. The water shutoff assembly recited in claim 19, wherein the water control axle defines an outer surface and a water key wall extending from the outer surface to define the water keyhole, the water key wall being configured to circumnavigate and engage the water valve stem when the water valve stem is received within the water keyhole.
